(19) United States
(12) Patent Application Publication
(10) Pub. No.: US 2025/0202063 A1
(43) Pub. Date: Jun. 19, 2025

(54) SEPARATOR FOR ELECTROCHEMICAL DEVICE, MATERIAL AND ELECTROCHEMICAL DEVICE

(71) Applicant: Koki SUWA, Niihama-shi, Ehime (JP)

(72) Inventor: Koki SUWA, Niihama-shi, Ehime (JP)

(21) Appl. No.: 18/976,686

(22) Filed: Dec. 11, 2024

(30) Foreign Application Priority Data
Dec. 13, 2023 (JP) 2023-210499

(51) Int. Cl. H01M 50/489; H01G 11/52; H01M 10/0525; H01M 50/417; H01M 50/423; H01M 50/449

(52) U.S. Cl. CPC H01M 50/489; H01G 11/52; H01M 10/0525; H01M 50/417; H01M 50/423; H01M 50/449

(57) ABSTRACT

Provided is a separator for an electrochemical device which separator has excellent heat resistance in a case where heat is externally applied to the separator. The separator of the present disclosure includes a polyolefin porous substrate and a porous layer formed on the polyolefin porous substrate, and has a thermal diffusivity of not more than 0.04 mm²/s at 25° C.

This Nonprovisional application claims priority under 35 U.S.C. § 119 on Patent Application No. 2023-210499 filed in Japan on Dec. 13, 2023, the entire contents of which are hereby incorporated by reference.

### TECHNICAL FIELD

The present invention relates to a separator for an electrochemical device (hereinafter referred to as a “separator”), a material for an electrochemical device (hereinafter referred to as a “material”), and an electrochemical device.

### BACKGROUND ART

Electrochemical devices, e.g., nonaqueous electrolyte secondary batteries, particularly lithium ion secondary batteries, have a high energy density, and are therefore widely used as batteries for personal computers, mobile telephones, portable information terminals, cars, and the like.

As a material of such a nonaqueous electrolyte secondary battery, a separator having excellent heat resistance is under development. For example, as in Patent Literature 1, a separator is known in which a heat-resistant layer containing an aramid resin and inorganic particles is formed on a porous substrate.

### CITATION LIST

### Patent Literature 1

International Publication No. WO 2019/176421

### SUMMARY OF INVENTION

### Technical Problem

In contrast, in a case where heat is externally applied to a conventional separator such as the separator disclosed in Patent Literature 1, thermal contraction and/or melting may occur in the entire separator due to transmission of the heat not only to a part of the separator which part is close to a heat source of the heat but also to the remaining part of the separator. Thus, the conventional separator has room for improvement in order to prevent or reduce occurrence of thermal contraction and/or melting in the entire separator in a case where heat is externally applied to the separator, i.e., in terms of heat resistance in a case where heat is externally applied to the separator.

An aspect of the present invention has an object to provide a separator that has excellent heat resistance in a case where heat is externally applied to the separator.

### Solution to Problem

The inventors of the present invention conducted diligent studies and consequently conceived of the present invention by finding that a separator whose thermal diffusivity has a low value which is not more than a specific value has excellent heat resistance in a case where heat is externally applied to the separator.

A separator in accordance with an aspect of the present invention includes a polyolefin porous substrate and a porous layer formed on the polyolefin porous substrate, and has a thermal diffusivity of not more than 0.04 mm²/s at 25° C.

### Advantageous Effects of Invention

An aspect of the present invention makes it possible to provide a separator that has excellent heat resistance in a case where heat is externally applied to the separator.

### DESCRIPTION OF EMBODIMENTS

The following description will discuss embodiments of the present invention. Note, however, that the present invention is not limited to the embodiments. Any numerical range expressed as “A to B” herein means “not less than A and not more than B” unless otherwise stated.

### [1. Separator]

A separator in accordance with an embodiment of the present invention includes a polyolefin porous substrate and a porous layer formed on the polyolefin porous substrate, and has a thermal diffusivity of not more than 0.04 mm²/s at 25° C.

Hereinafter, the “separator in accordance with an embodiment of the present invention” is also referred to simply as a “separator”. Further, the “polyolefin porous substrate” included in the separator is also referred to simply as a “porous substrate”. Furthermore, in the present specification, the “thermal diffusivity at 25° C.” is also referred to simply as a “thermal diffusivity”.

A separator in accordance with an embodiment of the present invention has a thermal diffusivity as low as not more than 0.04 mm²/s at 25° C. The thermal diffusivity means an area in which heat diffuses (moves) in the separator per unit time of 1 second (sec), and is a parameter that indicates a speed at which heat moves in the separator. Thus, the separator is a separator in which heat does not easily move.

Thus, in a case where heat is externally applied to the separator, even if heat contraction and/or melting occur(s) in a part of the separator which part is close to a heat source of the heat, the heat is not easily transmitted to the remaining part of the separator. Thus, even in a case where heat is externally applied to the separator, occurrence of heat contraction and/or melting is considered to be prevented or reduced in the entire separator. Examples of the part of the separator which part is close to the heat source of the heat include a surface layer part of the separator.

The separator is thus considered to have excellent heat resistance in a case where heat is externally applied to the separator.

The thermal diffusivity of the separator is preferably lower from the above-described viewpoint that the separator has excellent heat resistance in a case where heat is externally applied to the separator. Specifically, the thermal diffusivity is preferably not more than 0.040 mm²/s, more preferably not more than 0.037 mm²/s, and still more preferably not more than 0.035 mm²/s. Further, the thermal diffusivity may be not less than 0.010 mm²/s, may be not less than 0.020 mm²/s, or may be not less than 0.025 mm²/s.

The thermal diffusivity is defined by the following equation (1):

$$Thermal diffusivity [ {m}^{2} / s ] = thermal conductivity [ J / m \cdot s \cdot K ] / ( density [ g / {m}^{3} ] \times specific heat [ J / g \cdot K ] ) = thermal conductivity [ J / m \cdot s \cdot K ] / volumetric heat capacity [ J / {m}^{3} \cdot K ] \qquad ( 1 )$$

It can be understood from the equation (1) that in the separator, a high density and a high specific heat result in an increase in volumetric heat capacity and causes the thermal diffusivity to be controlled so as to have a low value. It can also be understood that in the separator, a low thermal conductivity causes the thermal diffusivity to be controlled so as to have a low value.

The separator includes a porous structure having voids (pores). Given that the void part has a weight of 0, unlike a density of a material which density has a constant value, a density of the separator can vary depending on a porosity of the separator. Specifically, the separator having a lower porosity tends to have a higher density.

The specific heat means a heat quantity (J) required to raise, by 1° C. (1 K), a temperature of a substance having a unit weight of 1 g. A substance whose temperature less easily increases in a case where a specific amount of heat is applied to the substance has a higher specific heat. Note here that the separator ordinarily contains a resin and optionally contains a filler. Further, air is ordinarily filled inside the voids of the separator, in which an air content varies depending on the porosity. Further, the resin, the filler, and the air have respective different specific heats. Thus, the specific heat can vary depending on a composition of the separator, that is, a resin content, a filler content, and an air content, i.e., the porosity.

It is known that a specific heat of the porous structure can vary depending on aspects of a pore distribution, e.g., a size of each pore, a size (thickness) of a part other than the pore, and the like. Thus, the specific heat of the separator can vary depending on not only the composition but also the aspects of the pore distribution, such as the size of each pore, a thickness of a resin part, and a particle diameter of the filler.

As above, by adjusting the porosity of the separator, the composition of the separator such as the resin content and the filler content, and the aspects of the pore distribution, it is possible to adjust the density and the specific heat in the separator in respective suitable ranges and consequently to control the thermal diffusivity of the separator in a suitable range.

In addition, the thermal conductivity can vary depending on a type of a substance constituting the separator. Thus, by selecting, as appropriate, the substance constituting the separator, i.e., a raw material of the separator, it is possible to adjust the thermal conductivity of the separator and consequently to control the thermal conductivity in a suitable range.

The thermal diffusivity is measured by a method that is not particularly limited and can be a known method, and preferably by a laser flash method. Note here that the laser flash method is a method which is in accordance with JIS R 1611 and which makes it possible to directly measure the thermal diffusivity without passing through a measurement of the thermal conductivity. More specific examples of the laser flash method include a method disclosed in Examples.

The separator includes a polyolefin porous substrate and a porous layer formed on the polyolefin porous substrate. That is, the separator is a separator in which the porous layer and the polyolefin porous substrate are formed on top of each other. The porous layer can be formed on one surface of the polyolefin porous substrate or on both surfaces of the polyolefin porous substrate.

The separator may be made of only the porous layer and the porous substrate. Alternatively, as described later, in the separator, a layer that is different from the porous layer and the porous substrate may be formed on at least one layer selected from the group consisting of the porous layer and the porous substrate. As a material included in the electrochemical device, the porous layer can be provided between the porous substrate and at least one of a positive electrode and a negative electrode. The porous layer may be provided between the porous substrate and at least one of the positive electrode and the negative electrode in a manner so as to be in contact with the porous substrate and the at least one of the positive electrode and the negative electrode. The number of porous layer(s) provided between the porous substrate and at least one of the positive electrode and the negative electrode may be one, two, or more. The porous layer is preferably an insulating layer.

The porous layer ordinarily contains a resin. The resin is not limited and is, for example, a nitrogen-containing aromatic resin. A nitrogen-containing aromatic resin means an aromatic resin containing a nitrogen atom. An aromatic resin means a resin containing a structural unit having at least an aromatic group.

Examples of the nitrogen-containing aromatic resin include aromatic polyamides such as a wholly aromatic polyamide (aramid resin) and a semi-aromatic polyamide, aromatic polyimides, aromatic polyamide imides, polybenzimidazoles, aromatic polyurethanes, and melamine resins. In particular, the nitrogen-containing aromatic resin preferably includes an aramid resin.

Examples of the aramid resin include para-aramids and meta-aramids. Among these, para-aramids are more preferable. Examples of the para-aramids include para-aramids each having a para-oriented structure or a quasi-para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), a paraphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Examples of the meta-aramids include poly(metaphenylene terephthalamide), poly(metaphenylene isophthalamide), poly(metabenzamide), poly(metaphenylene-4,4′-biphenylene dicarboxylic acid amide), and poly(metaphenylene-2,6-naphthalene dicarboxylic acid amide). Poly(metaphenylene isophthalamide) is also referred to as poly [N,N′-(1,3-phenylene) isophthalamide].

The resin is not particularly limited and is preferably two or more resins having different deposition properties during forming of the porous layer. Note here that the two or more resins having different deposition properties means two or more resins having different degrees of solubility in a solvent in a coating solution that is used to form the porous layer. The coating solution is a liquid obtained by dissolving and/or dispersing, in the solvent, a constituent material of the porous layer containing the resin. The two or more resins having different deposition properties with respect to a solvent in which the resin is dissolved preferably include, for example, two or more nitrogen-containing aromatic resins having different deposition properties. As the two or more resins having different deposition properties, it is preferable to combine resins having different structures, such as a resin having a rigid structure and a resin having flexibility. For example, poly(paraphenylene terephthalamide), poly(2-chloro-paraphenylene terephthalamide), poly(parabenzamide), and poly(4,4′-benzanilide terephthalamide) have a rigid structure. In contrast, poly(4,4′-diphenylsulfonyl terephthalamide), a paraphenylene terephthalamide/4,4′-diphenylsulfonyl terephthalamide copolymer, and a meta-aramid have flexibility. Note, however, that a combination of the two or more resins having different deposition properties is not limited to these combinations. The combination of the two or more resins having different deposition properties may be, for example, a combination of resins having relatively close structures, such as a combination of poly(paraphenylene terephthalamide) and poly(2-chloro-paraphenylene terephthalamide).

A proportion of a nitrogen-containing aromatic resin in 100% by weight of a resin contained in the porous layer is preferably more than 50% by weight, more preferably not less than 70% by weight, and still more preferably not less than 90% by weight. The proportion of the nitrogen-containing aromatic resin in 100% by weight of the resin contained in the porous layer may be not more than 100% by weight, or may be less than 100% by weight. The resin contained in the porous layer particularly preferably consists only of a nitrogen-containing aromatic resin.

The porous layer may contain a nitrogen-containing aromatic resin and a resin other than the nitrogen-containing aromatic resin. A proportion of the resin other than the nitrogen-containing aromatic resin in 100% by weight of the resin contained in the porous layer is preferably less than 50% by weight, more preferably not more than 30% by weight, and still more preferably not more than 10% by weight. The proportion of the resin other than the nitrogen-containing aromatic resin in 100% by weight of the resin contained in the porous layer may be not less than 0% by weight, or may be more than 0% by weight.

Examples of the resin other than the nitrogen-containing aromatic resin include polyolefin-based resins; (meth)acrylate-based resins; fluorine-containing resins; polyester-based resins; rubbers; resins each having a melting point or a glass transition temperature of not lower than 180° C.; water-soluble polymers; polycarbonates; and polyacetals. In an embodiment, the resin contained in the porous layer can be a resin that is not a polyester-based resin.

Examples of the polyester-based resins include aromatic polyesters such as a polyarylate and liquid crystal polyesters.

Examples of the rubbers include a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate.

Examples of the fluorine-containing resins include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkylvinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Examples of the resins each having a melting point or a glass transition temperature of not lower than 180° C. include polyphenylene ether, polysulfone, polyether sulfone, polyphenylene sulfide, polyetherimide, polyamide imide, polyether amide, and polyether ether ketone.

Examples of the water-soluble polymers include polyvinyl alcohol, polyethylene glycol, cellulose ether, sodium alginate, polyacrylic acid, polyacrylamide, and polymethacrylic acid.

The porous layer can be a heat-resistant layer. The heat-resistant layer means a layer having a higher melting temperature than a substrate. The resin contained in the porous layer can be a resin having heat resistance. The resin having heat resistance can be a resin having a higher melting point or glass transition temperature than a resin constituting the substrate. The resin contained in the porous layer is preferably a resin that is insoluble in an electrolyte of the electrochemical device and that is electrochemically stable when the electrochemical device is in normal use.

The porous layer can contain a filler. The filler can be an inorganic filler or an organic filler. The filler is preferably a filler made of an inorganic oxide such as silica, calcium oxide, magnesium oxide, titanium oxide, alumina, mica, zeolite, aluminum hydroxide, or boehmite, more preferably a filler made of calcium oxide, magnesium oxide, or alumina, and still more preferably a filler made of alumina.

A filler content in 100% by weight of the porous layer is preferably not less than 0% by weight and less than 20% by weight, more preferably 0% by weight to 15% by weight, still more preferably 0% by weight to 10% by weight, and particularly preferably 0% by weight to 5% by weight. A filler content of 0% by weight means that the porous layer does not contain the filler. In order to ensure ion permeability, the filler content in 100% by weight of the porous layer may be more than 0% by weight, or may be not less than 1% by weight. Note here that the filler content in the above preferable range is lower than a filler content in a conventional porous layer. It is commonly known that the filler has a lower specific heat than the resin constituting the porous layer. Thus, the filler content being lower than that in the conventional porous layer results in an increase in specific heat and a consequent decrease in thermal diffusivity in the separator. Thus, the filler content is preferably in the above range from the viewpoint that the thermal diffusivity of the separator is controlled so as to have a low value which is not more than 0.04 mm²/s.

The filler has an average particle diameter of preferably not more than 1 μm, more preferably not more than 800 nm, still more preferably not more than 500 nm, still more preferably not more than 100 nm, and still more preferably not more than 50 nm. The average particle diameter of the filler has a lower limit that is not particularly limited and that can be, for example, 5 nm. Note here that the average particle diameter of the filler is an average value of sphere equivalent particle diameters of 50 particles of the filler. Further, the sphere equivalent particle diameters of the filler are values obtained by actual measurement with use of a transmission electron microscope. The following is a specific example of a measurement method.
1. An image of the filler is captured by using a transmission electron microscope (TEM; JEOL Ltd., transmission electron microscope JEM-2100F) at an acceleration voltage of 200 kV and at a magnification ratio of 10,000 times with use of a Gatan Imaging Filter.
2. In the image thus obtained, an outline of a particle is traced by using image analysis software (ImageJ) and a sphere equivalent particle diameter of a filler particle (primary particle) is measured.
3. The above measurement is carried out for 50 filler particles that have been randomly extracted. An arithmetic average of sphere equivalent particle diameters of the 50 filler particles is regarded as the average particle diameter of the filler.

In order to ensure adhesion of the porous layer to an electrode and a high energy density, the porous layer has a thickness per layer of preferably 0.15 μm to 5 μm, more preferably 0.25 μm to 5 μm, and still more preferably 0.35 μm to 3 μm. The porous layer having a thickness per layer of not less than 0.15 μm (i) makes it possible to sufficiently prevent or reduce an internal short circuit which might occur due to, for example, breakage of the electrochemical device and (ii) allows the porous layer to retain an electrolyte in an adequate amount. Meanwhile, in a case where the porous layer has a thickness per layer of not more than 5 μm, in the electrochemical device, it is possible to minimize metal ion permeability resistance, and thus it is possible to minimize a decrease in rate characteristic and in cycle characteristic. Further, in a case where the porous layer has a thickness per layer of not more than 5 μm, it is also possible to minimize an increase in distance between the positive electrode and the negative electrode. This makes it possible to minimize a reduction in internal volume efficiency of the electrochemical device.

A weight per unit area of the porous layer can be determined as appropriate in view of the strength, thickness, weight, and handleability of the porous layer. The porous layer has a weight per unit area per layer of preferably 0.15 g/m² to 10 g/m², and more preferably 0.25 g/m² to 5 g/m². The porous layer having a weight per unit area in the above numerical range allows the electrochemical device to have a higher weight energy density and a higher volume energy density.

The porous layer has a porosity of preferably 20% by volume to 90% by volume, and more preferably 30% by volume to 80% by volume, in order to achieve sufficient ion permeability. Pores of the porous layer have a diameter of preferably not more than 1.0 μm, and more preferably not more than 0.5 μm. In a case where the pores have such a diameter, the electrochemical device can achieve sufficient ion permeability.

The polyolefin porous substrate means a porous substrate that contains a polyolefin-based resin as a main component. The phrase “contain a polyolefin-based resin as a main component” means that the polyolefin-based resin is contained, in the porous substrate, at a proportion of not less than 50% by weight, preferably not less than 90% by weight, and more preferably not less than 95% by weight with respect to all materials that constitute the porous substrate. The porous substrate can be a polyolefin porous film.

The polyolefin-based resin more preferably contains a high molecular weight component having a weight-average molecular weight of 5×10⁵ to 15×10⁶. In particular, the polyolefin-based resin that contains a high molecular weight component having a weight-average molecular weight of not less than 1,000,000 is more preferable because such a polyolefin-based resin allows a resulting separator to have increased strength.

The polyolefin-based resin is exemplified by, but not particularly limited to, thermoplastic resins each obtained by polymerizing a monomer(s) such as ethylene, propylene, 1-butene, 4-methyl-1-pentene, 1-hexene, and/or the like, such as homopolymers and copolymers. Examples of the homopolymers include polyethylene, polypropylene, and polybutene. Examples of the copolymers include an ethylene-propylene copolymer.

Among the above examples of polyolefin-based resins, polyethylene is more preferable because polyethylene makes it possible to prevent a flow of an excessively large electric current to a separator at a lower temperature. Note that preventing the flow of an excessively large electric current is also referred to as “shutdown”. Examples of the polyethylene include low-density polyethylene, high-density polyethylene, linear polyethylene (ethylene-α-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The porous substrate has a thickness of preferably 4 μm to 40 μm, and more preferably 5 μm to 20 μm. The porous substrate having a thickness of not less than 4 μm makes it possible to sufficiently prevent an internal short circuit in the electrochemical device. Meanwhile, the porous substrate having a thickness of not more than 40 μm makes it possible to prevent an increase in size of the electrochemical device.

A weight per unit area of the porous substrate can be determined as appropriate in view of the strength, thickness, weight, and handleability of the porous substrate. Note, however, that the weight per unit area is preferably 4 g/m² to 20 g/m², more preferably 4 g/m² to 12 g/m², and still more preferably 5 g/m² to 10 g/m², so as to allow the electrochemical device to have a higher weight energy density and a higher volume energy density.

The porous substrate has therein many pores connected to one another. This allows a gas and a liquid to pass through the porous substrate from one side to the other side. The porous substrate has an air permeability of preferably 30 s/100 mL to 500 s/100 mL, and more preferably 50 s/100 mL to 300 s/100 mL. The porous substrate having the above air permeability can have sufficient ion permeability. The air permeability represents a value as measured in conformity with JIS P8117 with use of an Oken-type air permeability tester.

The porous substrate has a porosity of preferably 20% by volume to 90% by volume, and more preferably 30% by volume to 75% by volume, so as to (i) retain a larger amount of an electrolyte and (ii) obtain the function of reliably preventing a flow of an excessively large electric current at a lower temperature. In order to achieve sufficient ion permeability and prevent particles from entering the positive electrode and/or the negative electrode, the porous substrate has pores each having a pore diameter of preferably not more than 0.3 μm, and more preferably not more than 0.14 μm.

The separator has a thickness of preferably 5.5 μm to 45 μm, and more preferably 6 μm to 25 μm. The separator having a thickness of not less than 5.5 μm makes it possible to sufficiently prevent an internal short circuit in the electrochemical device. Meanwhile, the separator having a thickness of not more than 45 μm makes it possible to prevent an increase in size of the electrochemical device.

The separator has an air permeability of preferably 30 s/100 mL to 1,000 s/100 mL, more preferably 50 s/100 mL to 800 s/100 mL, and still more preferably 70 s/100 mL to 500 s/100 mL. The separator having the above air permeability can achieve sufficient ion permeability in the electrochemical device. The air permeability represents a value as measured in conformity with JIS P8117 with use of an Oken-type air permeability tester.

As described above, the separator having a lower porosity commonly tends to have a higher density. In particular, in separators that are equivalent in specific gravity of constituent substances, the separator having a lower porosity has a higher density than the separator having a higher porosity. Further, as described above, the separator having a high density results in an increase in volumetric heat capacity of the separator, so that the thermal diffusivity of the separator is controlled so as to have a low value. Thus, the separator preferably has a lower porosity from the viewpoint that the density of the separator is increased so that the thermal diffusivity of the separator is controlled so as to have a low value. Air filled in a hole(s) commonly has a lower specific heat than the resin constituting the porous layer. Thus, the separator having a low porosity results in an increase in resin content in the porous layer and a decrease in air content. This accordingly causes the separator to have a higher specific heat and consequently allows the thermal diffusivity to be controlled so as to have a low value. Therefore, from the viewpoint that the specific heat is increased so that the thermal diffusivity is suitably controlled so as to have a low value, the porosity of the separator is preferably controlled so as to have a low value. Specifically, the porosity of the separator has an upper limit that is preferably not more than 90% by volume, more preferably not more than 70% by volume, and still more preferably not more than 60% by volume. It is considered that the separator having a porosity which is not less than a specific value can suitably ensure ion permeability for functioning as the separator. In order to suitably ensure ion permeability of the separator as described above, the porosity of the separator has a lower limit that is preferably not less than 20% by volume, more preferably not less than 30% by volume, and still more preferably not less than 40% by volume.

As in the case of the matter described above pertaining to the porosity, the separator preferably has a higher density from the viewpoint that the thermal diffusivity is controlled so as to have a low value. From the above viewpoint, the separator has a density of preferably not less than 0.1 g/cm³, more preferably not less than 0.2 g/cm³, and still more preferably not less than 0.3 g/cm³. Further, the separator has a density of preferably not more than 1.5 g/cm³, more preferably not more than 1.0 g/cm³, and still more preferably not more than 0.8 g/cm³.

As shown in Comparative Examples and Examples of the present application, even the separator that has a small density has a low thermal diffusivity in some cases depending on the composition of the separator. Specifically, in the separator that contains a substance having a high thermal conductivity while having a high specific gravity, reducing a content of the substance in the separator causes the separator to have a lower thermal conductivity while having a lower density and a lower volumetric heat capacity. Thus, in this case, the thermal diffusivity of the separator can be controlled so as to have a low value. Examples of the substance having a high thermal conductivity while having a high specific gravity include a filler.

The separator may include, as necessary, another functional layer different from the above-described porous substrate and the above-described porous layer (e.g., heat-resistant layer), provided that the object of the present invention is not prevented from being attained. Examples of the another functional layer include known porous layers such as an adhesive layer and a protective layer.

The another functional layer can be provided on one surface of the separator or on both surfaces of the separator. In a case where the separator includes the above-described porous layer on both surfaces of the porous substrate, the another functional layer may be provided on the porous layer on both surfaces of the separator, or may be provided on the porous layer on one surface of the separator. In a case where the separator includes the above-described porous layer only on one surface of the porous substrate, the another functional layer may be provided on the porous layer, or may be provided on a surface of the porous substrate on which surface the porous layer is not provided. The another functional layer can be provided on an outermost layer of the separator.

For example, the separator further includes an adhesive layer separately from the above-described porous substrate and the above-described porous layer. In the present specification, the adhesive layer means a porous layer having adhesiveness. The adhesive layer can be provided on a surface of the separator which surface is in contact with the electrode. Examples of a component that is contained in the adhesive layer and that contributes to adhesiveness include an acrylic resin and PVDF.

### [2. Method for Producing Separator]

A coating solution obtained by dissolving or dispersing a resin in a solvent can be used to form the porous layer on the porous substrate so as to produce the separator. Note that the solvent can be described as being a dispersion medium in which a resin is dispersed. Examples of the resin include the above-listed nitrogen-containing aromatic resins and the above-listed resins other than the nitrogen-containing aromatic resins. Examples of a method for forming the coating solution include a mechanical stirring method, an ultrasonic dispersion method, a high-pressure dispersion method, and a media dispersion method.

The separator can be formed by, for example, (i) a method of applying the coating solution directly to a surface of a porous substrate and then removing the solvent, (ii) a method of applying the coating solution to an appropriate support, subsequently removing the solvent so as to form a porous layer, pressure-bonding the porous layer to the porous substrate, and peeling the support off, (iii) a method of applying the coating solution to a surface of an appropriate support, pressure-bonding the porous substrate to that surface, peeling the support off, and then removing the solvent, or (iv) a method of carrying out dip coating by immersing the porous substrate into the coating solution, and then removing the solvent.

The solvent preferably (i) does not have an adverse effect on the porous substrate, (ii) allows the resin to be uniformly and stably dissolved in the solvent, and (iii) allows the filler to be uniformly and stably dispersed in the solvent. Examples of the solvent include N-methyl-2-pyrrolidone (NMP), N,N-dimethylacetamide, N, N-dimethylformamide, acetone, and water.

The coating solution may contain a filler. As necessary, the coating solution may contain, as a component(s) other than the resin and the filler, for example, a disperser, a plasticizer, a surfactant, and/or a pH adjuster.

The coating solution can be applied to the porous substrate by a conventionally known method. Specific examples of such a method include a gravure coater method, a dip coater method, a bar coater method, and a die coater method.

In a case where the coating solution contains an aramid resin, the aramid resin can be deposited by applying moisture to a surface to which the coating solution is applied. The porous layer may be formed in this way. A specific method of applying moisture to the surface to which the coating solution is applied is exemplified by, but not particularly limited to, a method of exposing the surface to a high-humidity atmosphere, a method of spraying water with use of a spray or the like, and a method of blowing water vapor via a nozzle or the like.

A method for producing the porous substrate is not particularly limited. For example, a polyolefin resin composition in sheet form is produced by kneading a polyolefin-based resin together with a pore forming agent such as an inorganic bulking agent or a plasticizer, and optionally with another agent(s) such as an antioxidant, and then extruding the kneaded substances. The pore forming agent is then removed from the polyolefin resin composition in sheet form with use of a suitable solvent. Thereafter, the porous substrate can be produced by stretching the polyolefin-based resin composition from which the pore forming agent has been removed.

The inorganic bulking agent is exemplified by, but not particularly limited to, an inorganic filler, specific examples of which include calcium carbonate. The plasticizer is exemplified by, but not particularly limited to, a low molecular weight hydrocarbon such as liquid paraffin.

For example, a separator whose thermal diffusivity is controlled so as to have a low value of not more than 0.04 mm²/s can be produced by using, as the coating solution, a coating solution that has a low filler content or that contains no filler. As described earlier, it is commonly known that the filler has a lower specific heat than the resin constituting the porous layer. Thus, the specific heat of the separator including the porous layer containing the filler is considered to be increased in a case where the resin content is high, the filler content is low, or no filler is contained. It is therefore considered that using the coating solution that has a low filler content or that contains no filler allows a specific heat of a separator to be produced to be adjusted so as to have a high value, and consequently allows a thermal diffusivity of the separator to be controlled so as to be not more than 0.04 mm²/s.

It is commonly known that, in a case where a coating solution that has a low filler content or that contains no filler is used to form a porous layer, the porous layer formed has a low porosity. A porous layer that has a low porosity tends to have a higher density. Thus, it is also considered that using the coating solution that has a low filler content or that contains no filler allows a density of a separator to be produced to be adjusted so as to have a high value, and consequently allows a thermal diffusivity of the separator to be controlled so as to be not more than 0.04 mm²/s.

In contrast, in a case where the porosity is excessively low, an electrochemical device including the separator may have reduced performance due to reduced ion permeability of the porous layer. It is therefore considered preferable to ensure a certain porosity in the porous layer. In order to ensure a certain porosity as described above, it is preferable to employ a method in which a resin including two or more resins having different deposition properties or containing two or more components having different deposition properties is used as the resin in the coating solution. As a mechanism by which a certain porosity can be ensured by the above method, the following mechanism can be considered, though speculative. According to the above method, in the process of deposition, a resin or component (first resin or first component) that has high a deposition property and that is easily deposited is deposited earlier, whereas a resin or component (second resin or second component) that has a low deposition property and that is not easily deposited is deposited later. Due to compatibility between the first resin or the first component and a solvent, the second resin or the second component is deposited near the first resin or the first component that has been deposited earlier. It is considered that, since the resins or components thus deposited so as to be unevenly distributed make it possible to sufficiently form open pores even without using a filler or even in a case where a filler content is reduced as compared with a conventional filler content, it is possible to form a porous layer in which a certain porosity is ensured.

Further, a separator whose thermal diffusivity is controlled in a more suitable range can be produced by not only using a coating solution that has a low filler content or that contains no filler, but also adjusting a solid content concentration of the coating solution in a predetermined range. The solid content concentration of the coating solution is a sum of respective concentrations of solid contents in the coating solution, such as the resin and the filler. Specifically, by adjusting the solid content concentration of the coating solution in a predetermined range, a porosity of each of a resulting porous layer and a separator including the resulting porous layer can be controlled in the above preferable range. It is therefore considered that adjusting the solid content concentration of the coating solution in a predetermined range allows a density and a specific heat of a separator to be produced to be adjusted in respective suitable ranges, and consequently allows a thermal diffusivity of the separator to be controlled in a more suitable range.

For the above reason, specifically, the solid content in the coating solution is preferably 0.1% by weight to 10% by weight, more preferably 1% by weight to 8.0% by weight, and still more preferably 2.5% by weight to 6.0% by weight, with respect to a weight of the entire coating solution.

Further, a separator whose thermal diffusivity is controlled so as to be in a more suitable range can be produced by not only using a coating solution that has a low filler content or that contains no filler, but also controlling a condition for removal of the solvent so that the condition is in a predetermined range. Specifically, controlling the above condition for removal of the solvent makes it possible to form (deposit) a porous layer in which aspects of a pore distribution, such as a size of each pore, a thickness of a resin part, and a particle diameter of the filler have been adjusted in respective suitable ranges. As a result, it is possible to produce a separator in which the aspects of the pore distribution have been adjusted in the respective suitable ranges. It is therefore considered that controlling the condition for removal of the solvent so that the condition is in a predetermined range allows a specific heat of a separator to be produced to be adjusted in a suitable range, and consequently allows a thermal diffusivity of the separator to be controlled in a more suitable range.

Examples of the condition for removal of the solvent, in other words, a condition for deposition of the porous layer include a deposition time, a deposition temperature, and a deposition humidity. The deposition time means a period of time in which an operation to remove the solvent is started and then the porous layer is formed (deposited). The deposition temperature and the deposition humidity mean a temperature and a humidity, respectively, of an outside air (atmosphere) in contact with the coating solution during removal of the solvent so as to form (deposit) the porous layer. The deposition time is preferably 1 second to 120 seconds, more preferably 5 seconds to 90 seconds, and still more preferably 10 seconds to 60 seconds. The deposition temperature is preferably 0° C. to 100° C., more preferably 10° C. to 90° C., and still more preferably 20° C. to 80° C. The deposition humidity is preferably 20% to 100%, more preferably 40% to 90%, and still more preferably 50% to 80%.

### [3. Material, Electrochemical Device]

A material in accordance with an embodiment of the present invention includes a positive electrode, a separator described above, and a negative electrode, the positive electrode, the separator, and the negative electrode being arranged in this order. An electrochemical device in accordance with an embodiment of the present invention includes a separator described above.

The material and the electrochemical device each include the separator in accordance with an embodiment of the present invention which separator has excellent heat resistance in a case where heat is externally applied to the separator. Thus, the material brings about an effect of being capable of being used to produce an electrochemical device that is less likely to catch fire. Further, the electrochemical device brings about an effect of being less likely to catch fire.

Note here that “catching fire” means that an electrochemical device is burned due to fire generated outside the electrochemical device. Specific examples of “catching fire” include the following: in a device including a material that is an assembly of a plurality of electrochemical devices (cells), in a case where some of the electrochemical devices ignite, the remaining electrochemical devices are also burned due to heat caused by ignition of some of the electrochemical devices.

Examples of the electrochemical device include a secondary battery and a capacitor. Examples of the secondary battery include a nonaqueous electrolyte secondary battery such as a lithium ion secondary battery. Examples of the capacitor include an electric double layer capacitor. A nonaqueous electrolyte secondary battery is not particularly limited in shape and can have any shape such as the shape of a thin plate (sheet), a disk, a cylinder, or a prism such as a cuboid.

For example, the material can be formed by arranging the positive electrode, the above-described separator, and the negative electrode in this order. The porous layer can be provided between the porous substrate and at least one of the positive electrode and the negative electrode. The material is then placed in a container that serves as a housing for the electrochemical device. In this manner, it is possible to produce the electrochemical device. In the case of a nonaqueous electrolyte secondary battery, the container is filled with a nonaqueous electrolyte (described later) and then hermetically sealed while pressure is reduced in the container.

### <Positive Electrode>

The positive electrode is not limited to any particular one, provided that the positive electrode is one that is generally used as a positive electrode of an electrochemical device. Examples of the positive electrode include a positive electrode sheet having a structure in which an active material layer containing a positive electrode active material and a binding agent is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include a lithium-containing complex metal oxide containing lithium (Li) and at least one transition metal selected from the group consisting of V, Cr, Mn, Fe, Co, Ni, Cu, and Al. Examples of such a lithium-containing complex metal oxide include LiCoO₂, LiNiO₂, LiMn₂O₄, Li₂MnO₃, LiNiₓMn_{y}Co_{1-x-y}O₂[0<x+y<1], LiNiₓCo_{y}Al_{1-x-y}O₂[0<x+y<1], LiCr_{0.5}Mn_{0.5}O₂, LiFePO₄, Li₂FeP₂O₇, LiMnPO₄, LiFeBO₃, Li₃V₂(PO₄)₃, Li₂CuO₂, Li₂FeSiO₄, and Li₂MnSiO₄.

Examples of the electrically conductive agent include carbonaceous materials such as natural graphite, artificial graphite, cokes, carbon black (e.g., acetylene black), pyrolytic carbons, fibrous carbon materials, and fired products of and organic polymer compounds. Each of the above electrically conductive agents may be used alone. Alternatively, two or more of the above electrically conductive agents may be used in combination. A proportion of the electrically conductive agent in a positive electrode mix is preferably not less than 5 parts by mass and not more than 20 parts by mass with respect to 100 parts by mass of the positive electrode active material. The proportion can be reduced in a case where a fibrous carbon material such as graphitized carbon fiber or a carbon nanotube is used as the electrically conductive agent.

The binding agent can be a thermoplastic resin. Examples of the thermoplastic resin include fluorine-based resins such as PVdF, polytetrafluoroethylene (PTFE), a tetrafluoroethylene-hexafluoropropylene-vinylidene fluoride-based copolymer, a hexafluoropropylene-vinylidene fluoride-based copolymer, and a tetrafluoroethylene-perfluorovinyl ether-based copolymer, acrylic resins, styrene butadiene rubber, polyimide resins, and polyolefin resins. Note that the binding agent serves also as a thickener. It is possible to use a mixture of two or more of these thermoplastic resins. A positive electrode mix that has both great adhesion to the positive electrode current collector and a high bonding strength inside the positive electrode mix can be obtained by using a fluororesin and a polyolefin resin as a binder to adjust a ratio of the fluororesin to all the positive electrode mix to not less than 1% by mass and not more than 10% by mass, and adjust a ratio of the polyolefin resin to all the positive electrode mix to not less than 0.1% by mass and not more than 2% by mass.

Examples of the positive electrode current collector include electric conductors such as Al, Ni, and stainless steel. Among these electric conductors, Al is more preferable because Al is easily processed into a thin film and is inexpensive.

Examples of a method for producing the positive electrode sheet include: a method in which the positive electrode active material, the electrically conductive agent, and the binding agent (positive electrode mix) are pressure-molded on the positive electrode current collector; and a method in which (i) the positive electrode mix is formed into a paste with use of an appropriate organic solvent, (ii) the positive electrode current collector is coated with the paste, and (iii) the paste is dried and then pressure is applied so that the paste is firmly fixed to the positive electrode current collector.

Examples of an organic solvent that can be used in the above method include: amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and NMP.

Examples of a method of applying a paste of the positive electrode mix to the positive electrode current collector include a slit-die coating method, a screen coating method, a curtain coating method, a knife coating method, a gravure coating method, and an electrostatic spray method.

### <Negative Electrode>

The negative electrode is not limited to any particular one, provided that the negative electrode is one that is generally used as a negative electrode of an electrochemical device. Examples of the negative electrode include a negative electrode sheet having a structure in which an active material layer containing a negative electrode active material and a binding agent is formed on a negative electrode current collector. The active material layer may further contain an electrically conductive agent.

Examples of the negative electrode active material include materials each capable of being doped with and dedoped of metal ions such as lithium ions or sodium ions. Examples of the materials include materials which are carbonaceous materials, chalcogen compounds (such as oxides and sulfides), nitrides, metals, and alloys and each of which is capable of being doped with and dedoped of lithium ions at electric potentials lower than that of the positive electrode. Examples of the carbonaceous materials include natural graphite, artificial graphite, cokes, carbon black, and pyrolytic carbons.

Examples of the oxides that can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VOₓ (where x is a positive real number), such as V₂O₅ and VO₂; oxides of iron which are represented by a formula FeOₓ (where is a positive real number), such as Fe₃O₄, Fe₂O₃, and FeO; oxides of tin which are represented by a formula SnOₓ (where x is a positive real number), such as SnO₂ and SnO; oxides of tungsten which are represented by a general formula WOₓ (where x is a positive real number), such as WO₃ and WO₂; and complex metal oxides each of which contains lithium and titanium or vanadium, such as Li₄Ti₅O₁₂ and LiVO₂.

Examples of the sulfides that can be used as the negative electrode active material include: sulfides of titanium which are represented by a formula TiSₓ (where x is a positive real number), such as Ti₂S₃, TiS₂, and TiS; sulfides of vanadium which are represented by a formula VSₓ (where x is a positive real number), such as V₃S₄, VS₂, and VS; sulfides of iron which are represented by a formula FeSₓ (where x is a positive real number), such as Fe₃S₄, FeS₂, and FeS; sulfides of molybdenum which are represented by a formula MoSₓ (where x is a positive real number), such as Mo₂S₃ and MoS₂; sulfides of tin which are represented by a formula SnSₓ (where x is a positive real number), such as SnS₂ and SnS; sulfides of tungsten which are represented by a formula WSₓ (where x is a positive real number), such as WS₂; sulfides of antimony which are represented by a formula SbSₓ (where x is a positive real number), such as Sb₂S₃; and sulfides of selenium which are represented by a formula SeSₓ (where x is a positive real number), such as SesS₃, SeS₂, and SeS.

Examples of the nitrides that can be used as the negative electrode active material include lithium-containing nitrides such as Li₃N and Li₃₋ₓAₓN (where A is one or both of Ni and Co, and 0<x<3 is satisfied).

Each of these carbonaceous materials, oxides, sulfides, and nitrides may be used alone. Alternatively, two or more of these carbonaceous materials, oxides, sulfides, and nitrides may be used in combination. These carbonaceous materials, oxides, sulfides, and nitrides may be each crystalline or amorphous.

Examples of the metals that can be used as the negative electrode active material include lithium metals, silicon metals, and tin metals.

Examples of the alloys that can be used as the negative electrode active material include lithium alloys such as Li—Al, Li—Ni, Li—Si, Li—Sn, and Li—Sn—Ni; silicon alloys such as Si—Zn; tin alloys such as Sn—Mn, Sn—Co, Sn—Ni, Sn—Cu, and Sn—La; and alloys such as Cu₂Sb and La₃Ni₂Sn₇.

These metals and alloys are each mainly solely used as an electrode after being processed into, for example, foil form. Among the above-listed negative electrode active materials, a carbonaceous material that contains, as a main component, graphite such as natural graphite or artificial graphite is preferably used. This is because such a carbonaceous material hardly changes in electric potential of a negative electrode (has good potential evenness) from an uncharged state to a fully charged state during charging, has a low average discharge potential, and has a high capacity maintenance rate (has a good cycle characteristic) when charging and discharging are repeatedly carried out. The shape of the carbonaceous material may be, for example, any of the following: a flake shape like natural graphite; a spherical shape like mesocarbon microbeads; a fibrous shape like graphitized carbon fiber; an aggregate of fine powders; and the like.

Examples of the negative electrode current collector include Cu, Ni, and stainless steel. Among these materials, Cu is more preferable because Cu is not easily alloyed with lithium and is easily processed into a thin film.

Examples of a method for producing the negative electrode sheet include: a method in which the negative electrode active material is pressure-molded on the negative electrode current collector; and a method in which (i) the negative electrode active material is formed into a paste with use of an appropriate organic solvent, (ii) the negative electrode current collector is coated with the paste, and (iii) the paste is dried and then pressure is applied so that the paste is firmly fixed to the negative electrode current collector. The paste preferably contains any of the above-listed electrically conductive agents and any of the above-listed binding agents.

The negative electrode sheet may contain a binder, as necessary. The binder can be, for example, a thermoplastic resin, specific examples of which include PVdF, thermoplastic polyimides, carboxymethyl cellulose, and polyolefin resins.

### <Nonaqueous Electrolyte>

A nonaqueous electrolyte is not limited to any particular one, provided that the nonaqueous electrolyte is one that is generally used for an electrochemical device, e.g., a nonaqueous electrolyte secondary battery. The nonaqueous electrolyte can be, for example, a nonaqueous electrolyte containing an organic solvent and a lithium salt dissolved in the organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, LiN(SO₂C₂F₅)₂, LiN(SO₂CF₃)(COCF₃), Li(C₄F₉SO₃), Li₂B₁₀Cl₁₀, LiBOB (where BOB refers to bis(oxalato) borate), LiFSI (where FSI refers to bis(fluorosulfonyl)imide), lower aliphatic carboxylic acid lithium salt, and LiAlCl₄. Each of the above lithium salts may be used alone. Alternatively, two or more of the above lithium salts may be used in combination. Among these electrolytes, it is preferable to use at least one fluorine-containing lithium salt selected from the group consisting of LiPF₆, LiAsF₆, LiSbF₆, LiBF₄, LiCF₃SO₃, LiN(SO₂CF₃)₂, and LiC(SO₂CF₃)₃.

Examples of the organic solvent include: carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy) ethane; ethers such as 1,2-dimethoxyethane, 1,3-dimethoxypropane, pentafluoropropyl methylether, 2,2,3,3-tetrafluoropropyl difluoromethylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and solvents each prepared by further introducing a fluoro group into any of these organic solvents (i.e., solvents each prepared by substituting one or more hydrogen atoms of any of these organic solvents with one or more respective fluorine atoms). Each of the above organic solvents may be used alone. Alternatively, two or more of the above organic solvents may be used in combination. In particular, a mixed solvent containing a carbonate is preferable, and a mixed solvent containing a cyclic carbonate and an acyclic carbonate, and a mixed solvent containing a cyclic carbonate and an ether are more preferable. The mixed solvent containing a cyclic carbonate and an acyclic carbonate is preferably a mixed solvent containing ethylene carbonate, dimethyl carbonate, and ethyl methyl carbonate. The electrolyte that contains such a mixed solvent has many advantages of having a wide operating temperature range, being less prone to deterioration even when subjected to charging and discharging at a high current rate, being less prone to deterioration even when used for a long period of time, and being less prone to decomposition even when the negative electrode active material is a graphite material such as natural graphite or artificial graphite.

The present invention is not limited to the embodiments, but can be altered by a skilled person in the art within the scope of the claims. The present invention also encompasses, in its technical scope, any embodiment derived by combining technical means disclosed in differing embodiments.

An embodiment of the present invention may include the following features.

<1>A separator for an electrochemical device, including a polyolefin porous substrate and a porous layer formed on the polyolefin porous substrate, the separator having a thermal diffusivity of not more than 0.04 mm²/s at 25° C.
<2> The separator described in <1>, wherein the separator has a porosity of not less than 20% by volume and not more than 90% by volume.
<3> The separator described in <1> or <2>, wherein the separator has a density of not less than 0.1 g/cm³ and not more than 1.5 g/cm³.
<4> The separator described in any one of <1> to <3>, wherein the porous layer has a weight per unit area of not less than 0.15 g/m² and not more than 10 g/m².
<5> The separator described in any one of <1> to <4>, wherein the porous layer contains an aramid resin.
<6> The separator described in any one of <1> to <5>, further including an adhesive layer separately from the polyolefin porous substrate and the porous layer.
<7>A material including a positive electrode, a separator described in any one of <1> to <6>, and a negative electrode, the positive electrode, the separator, and the negative electrode being arranged in this order.
<8> An electrochemical device including a separator described in any one of <1> to <6>.
<9> The electrochemical device described in <8>, wherein the electrochemical device is a secondary battery or a capacitor.

### EXAMPLES

The following description will discuss an example of the present invention.

### [Measurement and Evaluation of Physical Properties]

Physical properties of porous layers disclosed in Examples and Comparative Examples and separators disclosed in Examples and Comparative Examples were measured and evaluated by the following method.

### <Thickness>

The thickness of a separator was measured with use of a high-accuracy digital measuring instrument (manufactured by Mitutoyo Corporation). Specifically, each of the separators was cut into a square piece with an 8 cm side, and measurement was carried out at five points in the square piece. The thickness of the separator was determined from an average value of measurements obtained at the five points.

### <Thermal Diffusivity>

The separators in Examples and Comparative Examples were each cut out into a circular specimen with having a diameter of 19.0 mm. After the above specimen was pretreated under the following conditions, a thermal diffusivity at 25° C. of the specimen was measured with use of a laser flash apparatus (LFA467 HyperFlash manufactured by NETZSCH Inc.). The measured thermal diffusivity was regarded as a thermal diffusivity [mm²/s] of the separator.

### (Conditions)

Measurement method: laser flash method
Laser: irradiation wavelength of 1,064 nm, pulse width of 20 μm, voltage of 150 V
Detector: InSb (liquid nitrogen cooling)
Pretreatment: coating with graphite spray onto surface of specimen

### <Porosity>

A porosity of the separator was calculated by steps shown in 1, and 2. below.

Step 1. Parameters were defined as below.
Constituent materials of each layer: a, b, c, . . . , n
Respective weight ratios [% by weight] of constituent materials in each layer: Wa, Wb, Wc, . . . , Wn
Respective real densities [g/cm³] of constituent materials: da, db, dc, . . . , dn
Thickness [cm] of separator: t
   Step 2. From the parameters defined in step 1, a porosity & [% by volume] of a porous layer was calculated in accordance with the following equation (2):

$$ε [ \% by volume ] = [ 1 - \{ ( Wa / da + Wb / db + Wc / dc + … + Wn / dn ) / t \} ] \times 100 \qquad ( 2 )$$

Further, a density described in product information disclosed by a manufacturer was employed as a real density of the filler, a density described in Reference Document 1 below was employed as a real density of a resin A described later, and a density described in Reference Document 2 below was employed as a real density of a resin B described later.

Reference Document 1: K Xiao et al., J. Mater. Sci. 27 (1992) 3065 Reference Document 2: Takashi NOMA “Properties and Application of Aramid Fibers” in Special issue on “Gousei sen'i no kaihatsu doukou [Trends in development of synthetic fibers]”. Sen'i Gakkaishi [Journal of Fiber Science and Technology] (Sen′i To Kogyo), vol. 56, no. 8, pp. 241-247, 2,000

### <Weight Per Unit Area of Porous Layer>

A square sample measuring 8 cm×8 cm was cut out from a polyolefin porous film, which is a porous substrate to which a coating solution has not been applied. A weight of this sample was measured and regarded as W1 (g). A weight per unit area of the porous substrate was calculated in accordance with the following equation (3):

$$Weight per unit area of porous substrate [ g / {m}^{2} ] = W 1 [ g ] / ( 0.08 [ m ] \times 0.08 [ m ] ) \qquad ( 3 )$$

A square sample measuring 8 cm×8 cm was cut out from the separator. A weight of this sample was measured and regarded as W2 (g). A weight per unit area of the separator was calculated in accordance with the following equation (4):

$$Weight per unit area of separator [ g / {m}^{2} ] = W 2 [ g ] / ( 0.08 [ m ] \times 0.08 [ m ] ) \qquad ( 4 )$$

The measured weight per unit area of the separator and the measured weight per unit area of the porous substrate were used to calculate a weight per unit area of the porous layer in accordance with the following equation (5):

$$Weight per unit area of porous layer [ g / {m}^{2} ] = weight per unit area of separator [ g / {m}^{2} ] - weight per unit area of porous film [ g / {m}^{2} ] \qquad ( 5 )$$

### <Density>

The weight per unit area of the separator determined by the equation (4) and the thickness of the separator were used to calculate a density of the separator in accordance with the following equation (6):

$$Density of separator [ g / {cm}^{3} ] = weight per unit area of separator [ g / {cm}^{2} ] / thickness of separator [ cm ] \qquad ( 6 )$$

<Shape Retention Rate after Heating>

A shape retention rate after heating of the separator was measured by the following procedure.

1. A separator obtained in Examples or Comparative Examples was cut out into a square sample measuring 80 mm×80 mm. In so doing, the sample was cut out so that each side of the square was parallel to either an MD direction or a TD direction.
2. Inside an 80 mm×80 mm outer periphery of the sample cut out in 1., lines were drawn so as to describe a square measuring 60 mm×60 mm. In so doing, the lines were drawn so that each side of the square was parallel to either the MD direction or the TD direction of the sample.
3. The sample having been subjected to the operation in 2. was sandwiched between sheets of paper, and the sample sandwiched between the sheets of paper was placed inside an oven heated at 130° C. and was allowed to stand for 1 hour.
4. The sample after heating was removed from the oven after 1 hour of standing in 3. A length D_{MD} [mm] of a line parallel to the MD direction in the square described on the removed sample was measured with use of a digital vernier caliper.
5. A value of D_{MD} [mm] measured in 4. was used to calculate a degree of deformation in the MD direction as the shape retention rate after heating on the basis of the following equation (7):

$$Shape retention rate after heating [ \% ] = ( {D}_{MD} [ mm ] / 60 [ mm ] ) \times 100 \qquad ( 7 )$$

### <Soldering Iron Test>

A separator obtained in Examples or Comparative Examples was cut out to a size of 40 mm×60 mm to prepare a soldering iron test sample. The soldering iron test sample was placed so as to cover an opening of a 80 mm×80 mm metal sample base. The opening is positioned at a center of the metal sample base, and has dimensions of 20 mm in length by 20 mm in width by 4 mm in depth. The soldering iron test sample was placed so that a surface corresponding to a surface of the separator on which surface the porous layer is provided is facing upwards.

Next, with use of a polyimide adhesive tape manufactured by Nitto Denko Corporation, a short side of the soldering iron test sample was fixed to the metal sample base such that no wrinkles are created. Subsequently, the metal sample base, on which the soldering iron test sample is fixed, was placed on a precision jack. Further, a soldering iron was placed above the precision jack with use of a clamp. RX-80HRT-B manufactured by Taiyo Electric Ind. Co., Ltd. was used as a soldering bit of the soldering iron. A temperature of the soldering bit was set to 450° C. Thereafter, until the soldering bit perforated the soldering iron test sample and then came into contact with a bottom of the opening of the metal sample base, the precision jack was used to raise the metal sample base, on which the soldering iron test sample is fixed. After the soldering bit came into contact with the bottom of the opening of the metal sample base, the height of the metal sample base was maintained for five seconds, and the precision jack was subsequently used to lower the metal sample base, on which the soldering iron test sample is fixed. This produced a soldering iron test sample having a through hole. A photograph of the soldering iron test sample having the through hole was taken. In so doing, the photograph included a 1-cm line which was drawn near the soldering iron test sample having the through hole so that a scale of the through hole can be recognized. Next, with use of image analysis software “Image J”, a line was drawn along the shape of the through hole of the soldering iron test sample having the through hole, and an area of the through hole was calculated. As a result, a case where the through hole has an area of less than 0.1 cm² was regarded as “test passed”, and a case where the through hole has an area of not less than 0.1 cm² was regarded as “test failed”.

### Synthesis Example 1: Synthesis of Resin A

The resin A (poly(4,4′-diphenylsulfonyl terephthalamide)) was synthesized by the following procedure. Note that the resin A had a real density of 1.28 g/cm³.

1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, 31.97 g of 4,4′-diaminodiphenylsulfone was added at 100° C., and then a resulting mixture was completely dissolved.
4. A resulting solution was cooled to room temperature. While the temperature of the solution was maintained at 25±2° C., 25.88 g in total of terephthalic acid dichloride was added in 3 separate portions.
5. While the temperature of a resulting solution was maintained at 25+2° C., the solution was matured for 1 hour to obtain the solution that contained the resin A.

### Synthesis Example 2: Synthesis of Resin B

The resin B (poly(paraphenylene terephthalamide)) was synthesized by the following procedure. Note that the resin B had a real density of 1.44 g/cm³.

1. A 0.5-L separable flask having a stirring blade, a thermometer, a nitrogen incurrent canal, and a powder addition port was sufficiently dried.
2. 408.6 g of NMP was introduced into the flask. Further, 31.4 g of calcium chloride (having been dried at 200° C. for 2 hours) was added, and a resulting mixture was heated to 100° C.
3. After the calcium chloride completely dissolved, the temperature of a resulting solution was returned to room temperature. Subsequently, 13.20 g of paraphenylenediamine was added and completely dissolved.
4. While the temperature of a resulting solution was maintained at 25+2° C., 24.24 g in total of terephthalic acid dichloride was added in 3 separate portions.
5. While the temperature of a resulting solution was maintained at 25+2° C., the solution was matured for 1 hour to obtain the solution that contained the resin B.

### Example 1

A separator including a porous layer that contained the resin A and the resin B at a weight ratio of 50:50 was produced. Specifically, the solutions obtained in Synthesis Examples 1 and 2 were mixed so that the weight ratio between the resin A and the resin B was 50:50. To 500 g of a resulting mixture (1), 11.68 g of calcium carbonate was added. A resulting solution was stirred for 10 minutes so as to be neutralized. Thus, a neutralized solution (1) was obtained. Subsequently, the neutralized solution (1) was diluted with NMP and defoamed under reduced pressure to prepare a coating solution (1) in slurry form. The coating solution (1) had a solid content concentration of 4.5% by weight.

The coating solution (1) was applied to a polyethylene porous film (thickness: 10.3 μm, air permeability: 180 s/100 mL) so that a porous layer (1) was deposited under deposition conditions of 50° C. and a humidity of 70%. Note that a deposition time was set to 60 seconds. Thereafter, the resulting polyethylene porous film was washed with water and dried to obtain a laminated separator including the porous layer (1). The laminated separator thus obtained was regarded as a separator (1). The separator (1) had a thickness of 12.8 μm.

### Example 2

A separator including a porous layer that contained the resin A, the resin B, and the alumina (average particle diameter: 13 nm) at a weight ratio of 50:50:20 was produced. Specifically, operations were carried out in the same manner as in Example 1 to obtain a laminated separator including a porous layer (2), except for operations shown in (i) and (ii) below. The laminated separator thus obtained was regarded as a separator (2). The separator (2) had a thickness of 12.8 μm. The alumina had a real density of 3.27 g/cm³.

(i) The alumina (average particle diameter: 13 nm) was added to the neutralized solution (1) so that the weight ratio among the resin A, the resin B, and the alumina was 50:50:20, and a resulting solution was further diluted with NMP and defoamed under reduced pressure to prepare a coating solution (2) in slurry form instead of the coating solution (1).
(ii) Instead of the coating solution (1), the coating solution (2) was applied to the polyethylene porous film.

### Example 3

A separator including a porous layer that contained the resin A and the resin B at a weight ratio of 30:70 was produced. Specifically, operations were carried out in the same manner as in Example 1 to obtain a laminated separator including a porous layer (3), except for operations shown in (iii) and (iv) below. The laminated separator thus obtained was regarded as a separator (3). The separator (3) had a thickness of 11.5 μm. (iii) A neutralized solution (2) in which the weight ratio between the resin A and the resin B was 30:70 was prepared, and the neutralized solution (2) was further diluted with NMP and defoamed under reduced pressure to prepare a coating solution (3) in slurry form instead of the coating solution (1). Note here that the neutralized solution (2) was prepared by the same method as the method of preparing the neutralized solution (1), except that the solutions obtained in Synthesis Examples 1 and 2 were mixed so that the weight ratio between the resin A and the resin B was 30:70.

(iv) Instead of the coating solution (1), the coating solution (3) was applied to the polyethylene porous film.

### Comparative Example 1

A separator including a porous layer that contained the resin B and the alumina (average particle diameter: 13 nm) at a weight ratio of 100:100 was produced. Specifically, operations were carried out in the same manner as in Example 1 to obtain a laminated separator including a porous layer (4), except for operations shown in (v) to (vii) below. The laminated separator thus obtained was regarded as a comparative separator (1). The comparative separator (1) had a thickness of 11.7 μm.

(v) To 500 g of the solution obtained in Synthesis Example 2, 11.68 g of calcium carbonate was added. A resulting solution was stirred for 10 minutes so as to be neutralized. Thus, a neutralized solution (3) was obtained instead of the neutralized solution (1).
(vi) The neutralized solution (3) was diluted with NMP and defoamed under reduced pressure to prepare a coating solution (4) in slurry form instead of the coating solution (1).
(vii) Instead of the coating solution (1), the coating solution (4) was applied to the polyethylene porous film.

### Results

Table 1 shows production conditions in Examples and Comparative Examples, specifically, weight ratios of used raw materials and results of evaluation of the produced porous layers and the produced separators.

TABLE 1

| | Production condition | | | |
|---|---|---|---|---|
| | Weight ratio of raw material | | | Filler content |
| | | | Filler | in porous layer |
| | Resin A | Resin B | (alumina) | [% by weight] |
| Example 1 | 50 | 50 | 0 | 0 |
| Example 2 | 50 | 50 | 20 | 17 |
| Example 3 | 30 | 70 | 0 | 0 |
| Comparative | 0 | 100 | 100 | 50 |
| Example 1 | | | | |

| | Evaluation result | | | | | |
|---|---|---|---|---|---|---|
| | Porous layer | Separator | | | | |
| | Weight per | Thermal | Porosity | | Shape retention | |
| | unit area | diffusivity | [% by | Density | rate after | Soldering |
| | [g/m²] | [mm²/s] | volume] | [g/cm³] | heating [%] | iron test |
| Example 1 | 0.90 | 0.029 | 47 | 0.55 | 96 | Test |
| | | | | | | passed |
| Example 2 | 1.1 | 0.033 | 62 | 0.49 | 94 | Test |
| | | | | | | passed |
| Example 3 | 0.85 | 0.032 | 46 | 0.56 | 98 | Test |
| | | | | | | passed |
| Comparative | 0.90 | 0.043 | 43 | 0.61 | 86 | Test |
| Example 1 | | | | | | failed |

As shown in Table 1, the separators (1) to (3) each have a thermal diffusivity of not more than 0.04 mm²/s at 25° C. Thus, the separators (1) to (3) each fall under the separator in accordance with an embodiment of the present invention. In contrast, the comparative separator (1) has a thermal diffusivity of more than 0.04 mm²/s at 25° C., and thus does not fall under the separator in accordance with an embodiment of the present invention.

Further, as compared with the comparative separator (1), the separators (1) to (3) each have a high shape retention rate after heating and each have passed the soldering iron test. Thus, as compared with the comparative separator (1), even in a case where heat is externally applied to the separators (1) to (3), occurrence of thermal contraction and/or melting is reduced or prevented in the entire separator in each of the separators (1) to (3). Thus, it has been proved that the separators (1) to (3) have excellent heat resistance in a case where heat is externally applied to the separators (1) to (3).

Note that, as shown in Table 1, the comparative separator (1) satisfies conditions of “having a low porosity” and “having a high density” under which conditions a low thermal diffusivity is generally considered to be achieved, but has a high thermal diffusivity. This is considered to be because the comparative separator (1) contains a filler having a high thermal conductivity while having a high specific gravity, and a content of the filler in the comparative separator (1) is high. In contrast, as compared with the comparative separator (1), the separators (1) to (3) “have a high porosity” and “have a low density”, but have a low thermal diffusivity. This is considered to be because none of the separators (1) to (3) contain the filler having a high thermal conductivity while having a high specific gravity, or a content of the filler in each of the separators (1) to (3) is low.

The above has proved that the separator in accordance with an embodiment of the present invention has excellent heat resistance in a case where heat is externally applied to the separator.

### INDUSTRIAL APPLICABILITY

An aspect of the present invention is applicable to an electrochemical device.

1. A separator for an electrochemical device, comprising a polyolefin porous substrate and a porous layer formed on the polyolefin porous substrate,
the separator having a thermal diffusivity of not more than 0.04 mm²/s at 25° C.

2. The separator of claim 1, wherein the separator has a porosity of not less than 20% by volume and not more than 90% by volume.

3. The separator of claim 1, wherein the separator has a density of not less than 0.1 g/cm³ and not more than 1.5 g/cm³.

4. The separator of claim 1, wherein the porous layer has a weight per unit area of not less than 0.15 g/m² and not more than 10 g/m².

5. The separator of claim 1, wherein the porous layer contains an aramid resin.

6. The separator of claim 1, further comprising an adhesive layer separately from the polyolefin porous substrate and the porous layer.

7. A material comprising a positive electrode, a separator recited in claim 1, and a negative electrode, the positive electrode, the separator, and the negative electrode being arranged in this order.

8. An electrochemical device comprising a separator recited in claim 1.

9. The electrochemical device of claim 8, wherein the electrochemical device is a secondary battery or a capacitor.
